(19) United States
(12) Patent Application Publication
(10) Pub. No.: US 2024/0402405 A1
(43) Pub. Date: Dec. 5, 2024

(54) LAMINATE FOR RADIATIVE COOLING, AND RADIATIVE COOLING MATERIAL INCLUDING THE SAME

(71) Applicants: Hyundai Motor Company, Seoul (KR); Kia Corporation, Seoul (KR)

(72) Inventors: Min Jae Lee, Seongnam-si (KR); Min Soo Kim, Suwon-si (KR); Byung Hong Lee, Suwon-si (KR)

(21) Appl. No.: 18/663,800

(22) Filed: May 14, 2024

(30) Foreign Application Priority Data
May 31, 2023 (KR) 10-2023-0070449
Dec. 8, 2023 (KR) 10-2023-0178081

(51) Int. Cl. G02B 5/28

(52) U.S. Cl. CPC G02B 5/282

(57) ABSTRACT

An embodiment laminate for radiative cooling includes a first light reflecting layer, a second light reflecting layer on the first light reflecting layer, and an infrared radiating layer on the second light reflecting layer, wherein the first light reflecting layer has a reflectance equal to or higher than 80% for near-infrared light with a wavelength in a range from 780 to 1,300 nm and a transmittance equal to or higher than 70% for visible light with a wavelength in a range from 400 to 780 nm, and wherein a first metal protective layer, a metal layer, and a second metal protective layer are sequentially stacked in the second light reflecting layer.

### CROSS-REFERENCE TO RELATED APPLICATIONS

This application claims the benefit of Korean Patent Application No. 10-2023-0070449, filed on May 31, 2023, and Korean Patent Application No. 10-2023-0178081, filed on Dec. 8, 2023, which applications are hereby incorporated herein by reference.

### TECHNICAL FIELD

The present disclosure relates to a laminate for vehicle radiative cooling and a radiative cooling material including the same.

### BACKGROUND

In general, energy consumption is essential for cooling. For example, a general-purpose cooling apparatus, such as a refrigerator and an air conditioner, uses energy to compress refrigerant and then performs the cooling using absorption of heat generated when the compressed refrigerant expands. Unlike the general-purpose cooling apparatus, radiative cooling is a technology that may perform the cooling without wasting the energy. To improve a radiative cooling efficiency, it is important to well control the absorption, reflection, and radiation of light in each wavelength band. Most heat is generated from incident sunlight. The sunlight is divided into ultraviolet (UV) light, visible light, and infrared light. When reflecting light in each wavelength band, inflow of the heat via the sunlight may be blocked. For example, an internal temperature of a black vehicle that absorbs light well during a sunny day increases easily, but an internal temperature of a white vehicle that reflects light well rather than absorbs the same increases relatively slowly.

A variety of materials, such as a polymer, a multi-layer thin film made of an inorganic material or a ceramic material, a component for the radiative cooling including a metal reflective layer, and a paint containing a white pigment, are used as a material for the radiative cooling. The polymer material generally has a high absorptivity (an emissivity) for the infrared light, but it is easily deteriorated by the ultraviolet light, moisture, and the like when left outdoors because of a nature thereof and thus has a short lifespan. In the case of the multi-layer thin film, the number of layers must be increased to increase the emissivity for the infrared light, which increases an absorptivity of the sunlight, making it difficult to achieve a high-efficiency radiative cooling performance. In addition, the material including the metal reflective layer is difficult to be applied in real life because of low long-term stability caused by oxidation of metal and a unit cost issue. Because such metal material performs regular reflection, eye fatigue and light blur are caused. The paint containing the white pigment is generally not composed of a material with a high extinction coefficient, and thus it has an insufficient radiative cooling ability because of insufficient infrared emissivity and ultraviolet reflectance.

As an alternative to such problem, Korean Patent Application Publication No. 2019-0072514, published on Feb. 28, 2019, ('514 publication) discloses an infrared shielding sheet including a stacked film, in which a high refractive index resin layer containing fine particles and a low refractive index resin layer containing fine particles are alternately stacked, and an infrared absorbing dye layer having a visible light transmittance equal to or higher than 70%. However, the sheet of the '514 publication implements heat shielding by absorbing the infrared light, so that a surface temperature of the material increases, resulting in insufficient cooling performance and limitations in color rendering.

Therefore, there is a need for research and development on a material that is applicable to outdoor applications exposed to the sunlight for a long time by having excellent reflection for light in an ultraviolet band, excellent infrared radiation, excellent radiative cooling effect, and excellent durability.

### SUMMARY

The present disclosure relates to a laminate for vehicle radiative cooling and a radiative cooling material including the same. Particular embodiments relate to a laminate for vehicle radiative cooling that has excellent reflection for light in an ultraviolet band and excellent infrared radiation, and thus, has an excellent radiative cooling effect, and a radiative cooling material including the same.

Embodiments of the present disclosure can solve problems occurring in the prior art while advantages achieved by the prior art are maintained intact.

An embodiment of the present disclosure provides a laminate that has excellent reflection for light in an ultraviolet band, excellent infrared radiation to have excellent radiative cooling effect, and excellent durability to be applicable to outdoor applications exposed to sunlight for a long time, and a radiative cooling material including the same.

The technical problems solvable by embodiments of the present disclosure are not limited to the aforementioned problems, and any other technical problems not mentioned herein will be clearly understood from the following description by those skilled in the art to which the present disclosure pertains.

According to an embodiment of the present disclosure, a laminate for radiative cooling includes a first light reflecting layer having a reflectance equal to or higher than 80% for near-infrared light with a wavelength in a range from 780 to 1,300 nm and a transmittance equal to or higher than 70% for visible light with a wavelength in a range from 400 to 780 nm, a second light reflecting layer formed on the first light reflecting layer, wherein a first metal protective layer, a metal layer, and a second metal protective layer are sequentially stacked in the second light reflecting layer, and an infrared radiating layer formed on the second light reflecting layer.

According to another embodiment of the present disclosure, a radiative cooling material includes the laminate for the radiative cooling.

According to another embodiment of the present disclosure, a mobility includes the radiative cooling material.

### BRIEF DESCRIPTION OF THE DRAWINGS

The above and other objects, features, and advantages of embodiments of the present disclosure will be more apparent from the following detailed description taken in conjunction with the accompanying drawings, in which:

FIG. 1 is a cross-sectional view of a laminate for radiative cooling according to an embodiment of the present disclosure;

FIGS. 2 and 4 show emissivity measurement results of a laminate according to an example embodiment of the present disclosure;

FIGS. 3, 7, and 8 show reflectance measurement results of a laminate according to an example embodiment of the present disclosure;

FIG. 5 shows wear resistance measurement results of a laminate for radiative cooling according to an example embodiment of the present disclosure; and

FIG. 6 shows light resistance (haze) measurement results of a laminate according to an example embodiment of the present disclosure.

### DETAILED DESCRIPTION OF ILLUSTRATIVE EMBODIMENTS

Herein, when one component “includes” a certain component, this means that the one component may further include other components rather than excluding other components, unless specifically stated otherwise.

Herein, when one member is described to be located on a “surface”, “top”, “one surface,” “other surface,” or “both surfaces” of another member, this refers not only to a case in which the one member is in contact with said another member, but also to a case in which a third member exists between the two members.

In addition, herein, “a weight average molecular weight” may be measured by a method well known in the art, and it may represent, for example, a value measured by a gel permeation chromatograph (GPC) method.

### Laminate for Radiative Cooling

A laminate for radiative cooling according to embodiments of the present disclosure includes a first light reflecting layer, a second light reflecting layer formed on the first light reflecting layer, and an infrared radiating layer formed on the second light reflecting layer.

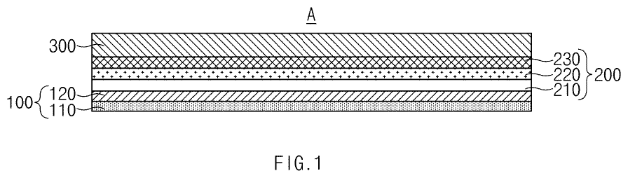

Referring to FIG. 1, a laminate A for radiative cooling according to embodiments of the present disclosure may have a form in which a first light reflecting layer 100, a second light reflecting layer 200, and an infrared radiating layer 300 are stacked in order. In this regard, the second light reflecting layer 200 has a form in which a first metal protective layer 210, a metal layer 220, and a second metal protective layer 230 are sequentially stacked. Additionally, the first light reflecting layer 100 may have a form in which a first layer 110 and a second layer 120 are alternately stacked.

### First Light Reflecting Layer

The first light reflecting layer serves to block heat by reflecting near-infrared light with a wavelength in a range from 780 to 1,300 nm.

Specifically, the first light reflecting layer has a reflectance equal to or higher than 80% for the near-infrared light, which is light with the wavelength in the range from 780 to 1,300 nm, and a transmittance equal to or higher than 70% for visible light with a wavelength in a range from 400 to 780 nm. More specifically, the first light reflecting layer may have a high reflectance in a range from 80 to 90% for the near-infrared light, which is light with the wavelength in the range from 780 to 1,300 nm, and a transmittance equal to or higher than 75% or in a range from 80 to 95% for the visible light with the wavelength in the range from 400 to 780 nm. Accordingly, the first light reflecting layer has an effect of improving a radiative cooling ability by reflecting the near-infrared light irradiated to the laminate.

In addition, the first light reflecting layer is preferably a polymer-containing layer rather than a metal-containing structure considering economic efficiency. Specifically, the first light reflecting layer may include a form in which the first layer containing a first polymer and the second layer containing a second polymer having a lower refractive index than the first layer are alternately stacked. When the first light reflecting layer includes the form in which the first layer and the second layer with the lower refractive index than the first layer are alternately stacked, the first layer with a relatively high refractive index and the second layer with a relatively low refractive index are stacked alternately to create interference therebetween and change a travel direction of light, thereby effectively blocking the heat.

Additionally, the first layer may have a refractive index equal to or higher than 1.4, in a range from 1.6 to 2.2, or in a range from 1.8 to 2.0. When the refractive index of the first layer is within the above range, the first layer and the second layer may create the interference therebetween and change the travel direction of light, thereby improving the radiative cooling ability of the laminate.

The second layer may have a refractive index equal to or higher than 1.3, equal to or higher than 1.5 and lower than 2.1, or equal to or higher than 1.7 and lower than 1.9. When the refractive index of the second layer is within the above range, the first layer and the second layer create the interference therebetween and change the travel direction of light, thereby improving the radiative cooling ability of the laminate.

Specifically, the first light reflecting layer may have the number of stacked layers of the first layer and the second layer in a range from 100 to 5000, from 400 to 2000, or from 500 to 1000.

The first light reflecting layer may have an average thickness in a range from 50 to 300 μm, from 60 to 270 μm, or from 75 to 250 μm. When the average thickness of the first light reflecting layer is smaller than the above range, hardness of the manufactured laminate may be insufficient or a decrease in near-infrared reflectance may occur. When the average thickness exceeds the above range, an increase in reflectance at an unwanted wavelength of the manufactured laminate, a decrease in visible light transmittance, and low economic feasibility caused by less obtainable effects compared to thickness may occur.

### Second Light Reflecting Layer

The second light reflecting layer serves to block the heat by reflecting the near-infrared light with a wavelength in a range from 1,300 to 2,500 nm and to improve durability of the laminate against sunlight.

The second light reflecting layer is formed on the first light reflecting layer and includes the form in which the first metal protective layer, the metal layer, and the second metal protective layer are sequentially stacked. The second light reflecting layer includes the form in which the first metal protective layer, the metal layer, and the second metal protective layer are sequentially stacked and improves reflectance for infrared light with a wavelength equal to or higher than 1,300 nm, thereby improving a radiative cooling performance of the manufactured laminate.

Each of the first metal protective layer and the second metal protective layer may independently contain at least one selected from a group consisting of indium-doped tin oxide (ITO, In-doped tin oxide), aluminum-doped zinc oxide (AZO, Al-doped Zn oxide), fluorine-doped tin oxide (FTO, Fluorine-doped tin oxide), titanium dioxide (TiO₂), neodymium oxide (Nd₂O₃), and silicon dioxide (SiO₂). When each of the first metal protective layer and the second metal protective layer contains the metal oxide as described above, a problem that the metal layer is exposed to air and is oxidized is prevented and the visible light transmittance is adjusted.

In addition, each of the first metal protective layer and the second metal protective layer may independently have an average thickness in a range from 15 to 200 nm, from 50 to 150 nm, or from 30 to 100 nm. When the average thickness of each of the first metal protective layer and the second metal protective layer is smaller than the above range, metal in the metal layer may be eluted by an external impact to reduce the durability of the manufactured laminate, or the metal layer may react with air and be easily oxidized to reduce durability of the metal layer, and the visible light transmittance may be reduced. When the average thickness exceeds the above range, the visible light transmittance of the manufactured laminate may be reduced or the near-infrared reflectance may be excessively increased.

For example, the metal layer may contain at least one selected from a group consisting of silver (Ag), aluminum (Al), gold (Au), aluminum oxide (Al₂O₃), chromium (Cr), and copper (Cu). When the metal layer contains at least one of the metals described above, the near-infrared reflectance of the laminate increases because of light interference.

Additionally, the metal layer may have an average thickness in a range from 1 to 100 nm, from 1 to 50 nm, from 1 to 30 nm, or from 1 to 20 nm. When the average thickness of the metal layer is smaller than the above range, the near-infrared reflectance of the manufactured laminate may be insufficient. When the average thickness exceeds the above range, the economic feasibility may be low because of the less obtainable effects compared to the thickness.

The second light reflecting layer may have an average thickness in a range from 30 to 300 nm, from 50 to 200 nm, or from 50 to 150 nm. When the average thickness of the second light reflecting layer is smaller than the above range, the near-infrared reflectance and the visible light transmittance of the manufactured laminate may be insufficient. When the average thickness exceeds the above range, the economic feasibility may be low because of less obtainable effects compared to the thickness of the second light reflecting layer.

### Infrared Radiating Layer

The infrared radiating layer may selectively radiate a portion of far-infrared light with a wavelength in a range from 4 to 20 μm. Accordingly, the infrared radiating layer serves to improve the radiative cooling performance of the laminate by dissipating the heat within the laminate containing the same. In this regard, a wavelength at which the infrared radiating layer selectively radiates the far-infrared light may be in a range from 8 to 14 μm.

The infrared radiating layer may contain a thermoplastic resin.

The thermoplastic resin may include, for example, at least one selected from a group consisting of polyester, acrylic resin, polyolefin, polyurethane, polystyrene (PS), cellulose-based resin, silicone, and copolymers thereof. For example, the thermoplastic resin may include at least one type of polymer selected from a group consisting of acrylonitrile-butadiene-styrene (ABS), polypropylene (PP), poly (methyl methacrylate) (PMMA), polymethylpentene (PMP), ethylene tetrafluoroethylene (ETFE), polydimethylsiloxane (PDMS), polylactic acid (PLA), polyethylene terephthalate (PET), and copolymers thereof. In this regard, the “polymer” may include a homopolymer or a blend or a copolymer obtained therefrom.

Specifically, the thermoplastic resin may include the acrylic resin such as the poly (methyl methacrylate) (PMMA). When the thermoplastic resin includes the acrylic resin such as the PMMA, a wear resistance of the laminate may be further improved.

In addition, the thermoplastic resin may have an emissivity in a range from 75 to 95% or from 80 to 90% for the wavelength in the range from 8 to 14 μm. That is, the thermoplastic resin may have excellent emissivity for the wavelength in the range from 8 to 14 μm and may selectively radiate the portion of the far-infrared light. When the emissivity of the thermoplastic resin is out of the above range, a surface temperature of the laminate may increase.

The infrared radiating layer may contain the thermoplastic resin and a filler. In this regard, the filler may be used without a particular limitation as long as it is generally applicable to the radiative cooling material, and may include, for example, silica (SiO₂).

Additionally, the infrared radiating layer may have an average thickness in a range from 10 to 1,000 μm, from 10 to 500 μm, or from 50 to 200 μm. When the average thickness of the infrared radiating layer is smaller than and/or exceeds the above range, the selective emissivity for the infrared light is reduced, which may reduce the radiative cooling ability of the laminate.

The laminate may additionally include an adhesive layer between the second light reflecting layer and the infrared radiating layer.

### Adhesive Layer

The adhesive layer serves to bond the second light reflecting layer and the infrared radiating layer to each other.

Additionally, the adhesive layer may include an ultraviolet light curable adhesive or a moisture curable adhesive. The adhesive layer may include at least one selected from a group consisting of an acrylic adhesive, a silicone-based adhesive, and a urethane-based adhesive.

The ultraviolet light curable adhesive may be used without a particular limitation as long as it is an adhesive that is generally cured by the ultraviolet light. For example, the ultraviolet light curable adhesive may be the acrylic adhesive containing an acrylic monomer and an ultraviolet photoinitiator.

The acrylic monomer may be used without a particular limitation as long as it is an acrylic monomer that is generally applicable to the ultraviolet light curable adhesive, and, for example, may include at least one selected from a group consisting of an alkyl (meth)acrylate monomer and an amide group-containing unsaturated (meth)acrylic monomer.

The ultraviolet photoinitiator may be used without a particular limitation as long as it is a photoinitiator that is generally applicable to the ultraviolet light curable adhesive, and it may be, for example, an acyl phosphine oxide-based compound.

The moisture curable adhesive may be used without a particular limitation as long as it is an adhesive that is generally cured by moisture in air. For example, the moisture curable adhesive may be the urethane-based adhesive. In this regard, the moisture curable adhesive may be a urethane-based adhesive containing a urethane-based prepolymer and polyisocyanate.

The urethane-based prepolymer may contain a hydroxyl group and may serve to cure the adhesive by reacting with polyisocyanate. Additionally, the urethane-based prepolymer may be used without a particular limitation as long as it is generally applicable to the urethane-based adhesive. Additionally, the polyisocyanate may be used without a particular limitation as long as it is generally applicable to the urethane-based adhesive.

The adhesive layer may have an average thickness in a range from 0.1 to 1.0 μm, from 0.15 to 0.75 μm, or from 0.2 to 0.5 μm. When the average thickness of the adhesive layer is smaller than the above range, each layer may peel because of insufficient adhesion between the layers. When the average thickness exceeds the above range, an infrared absorptivity of the manufactured laminate may increase.

The laminate may have an average thickness in a range from 100 to 1,100 μm or from 100 to 200 μm. When the average thickness of the laminate is within the above range, there are effects of reflecting the near-infrared light and radiating the far-infrared light. Additionally, the laminate may be manufactured using a roll-to-roll process for the average thickness to be within the above range.

The laminate for the radiative cooling according to embodiments of the present disclosure as described above has excellent reflection for light in a near-infrared light band with a wavelength in a range from 800 to 20,000 nm and has excellent infrared radiation, thereby having excellent radiative cooling effect. In addition, the laminate for the radiative cooling has excellent durability and wear resistance against the sunlight, so that the laminate is very suitable as an outdoor radiative cooling material exposed to the sunlight for a long time, such as on an exterior of a vehicle.

### Radiative Cooling Material

The radiative cooling material of embodiments of the present disclosure includes the laminate for the radiative cooling.

For example, the radiative cooling material may be a radiative cooling film for a vehicle roof. When the radiative cooling material is applied as the radiative cooling film for the vehicle roof, the durability and the wear resistance against the sunlight are excellent without affecting a color of the vehicle roof, and reflection for the ultraviolet light and the infrared radiation are excellent.

When the radiative cooling material is applied as the radiative cooling film for the vehicle roof, the first light reflecting layer of the laminate for the radiative cooling may be disposed on an exterior of the vehicle roof. Accordingly, the radiative cooling effect may be further improved as the laminate absorbs heat inside a mobility, which is located beneath the first light reflecting layer, and releases the heat to the outside of the infrared radiating layer.

As described above, the radiative cooling material has the excellent reflection for light in the near-infrared light band with the wavelength in the range from 800 to 20,000 nm and has the excellent infrared radiation, thereby having the excellent radiative cooling effect. In addition, the radiative cooling material has the excellent durability and wear resistance against the sunlight, so that the radiative cooling material is very suitable for outdoor applications exposed to the sunlight for a long time, such as the exterior of a vehicle.

### Mobility or Building

The mobility or the building of embodiments of the present disclosure contains the radiative cooling material. Accordingly, the mobility or the building is capable of saving cooling energy in summer or when exposed to strong sunlight, and thus has excellent energy efficiency.

In this regard, the mobility may include, for example, a vehicle, an aircraft, a train, a ship, or various mobile robots. Additionally, the building may be mobile or fixed.

Hereinafter, embodiments of the present disclosure will be described in more detail via present examples. However, such present examples are only intended to help understand embodiments of the present disclosure, and the scope of the embodiments of the present disclosure is not limited to such present examples in any way.

### Present Examples

### Test Example 1: Characteristic Evaluation

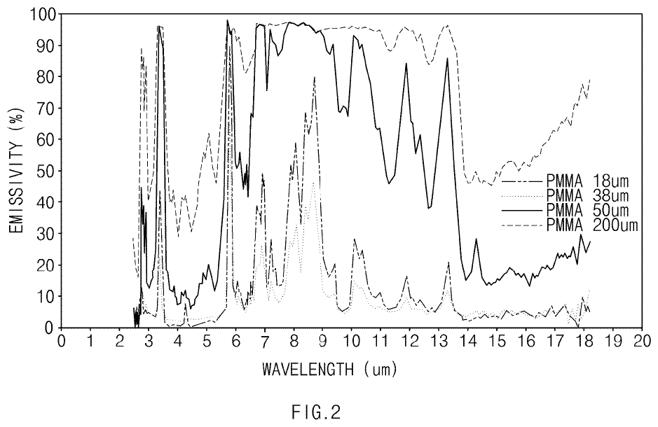

A change in a physical property based on a thickness of a film composed of the PMMA (weight average molecular weight (Mw): 52,000 g/mol) was evaluated by a following method, and results are shown in FIG. 2.

Specifically, an integrating sphere was mounted on a Fourier Transform Infrared (FT-IR) spectrometer and then emissivity for a wavelength in a range from 0.2 to 20 μm of the PMMA was measured.

As shown in FIG. 2, it was found that the PMMA film with a thickness of 50 μm has excellent emissivity in an atmospheric window wavelength in a range from 8 to 14 μm.

### Manufacture Example 1. Manufacture of Laminate

As the first light reflecting layer, a first light reflecting layer with an average thickness of 75 μm (transmittance for visible light [wavelength 400-780 nm]: 88% and reflectance for near-infrared light [wavelength 780-1300 nm]: 80%) (manufacturer: Toray Film, product name: PICASUS, high refractive index layer and low refractive index layer alternately stacked, each layer made of polymer) was used.

The first metal protective layer was formed on the first light reflecting layer to have an average thickness of 0.065 μm (65 nm) via a deposition method using an indium-doped tin oxide (ITO) target under an argon atmosphere, the metal layer was formed on the first metal protective layer to have an average thickness of 0.01 μm (10 nm) via a metal deposition method using an Ag planar target under the argon atmosphere, and the second metal protective layer was formed on the metal layer to have an average thickness of 0.065 μm (65 nm) using an ITO in the same manner as the formation of the first metal protective layer to manufacture a laminate-1.

Thereafter, the urethane-based adhesive was applied on the second metal protective layer to form a second adhesive layer with an average thickness of 0.2 μm.

Thereafter, the infrared radiating layer with an average thickness of 100 μm composed of the PMMA (weight average molecular weight (Mw): 52,000 g/mol) was stacked on the second adhesive layer to manufacture the laminate-1.

### Manufacture Example 2

3M's infrared light reflective film (product name: CR75, average thickness: 100 μm) was stacked on a base film with an average thickness of 50 μm composed of polycarbonate (PC, weight average molecular weight (Mw): 200,000 g/mol). Thereafter, the same first light reflecting layer (average thickness: 75 μm) as in Manufacture Example 1 was stacked on the infrared light reflective film, and a PET film with an average thickness of 50 μm composed of polyethylene terephthalate (PET) was stacked to manufacture a laminate-2.

### Test Example 2: Characteristic Evaluation

Physical properties of the laminate-1 of Manufacture Example 1 and the laminate-2 of Manufacture Example 2 were evaluated by a following method.

### (1) Measurement of Reflectance and Emissivity

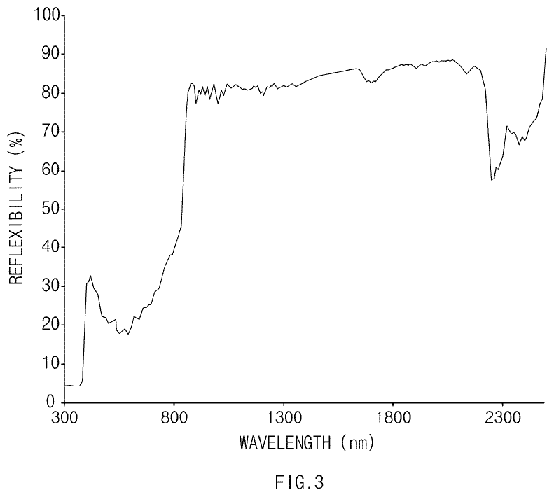

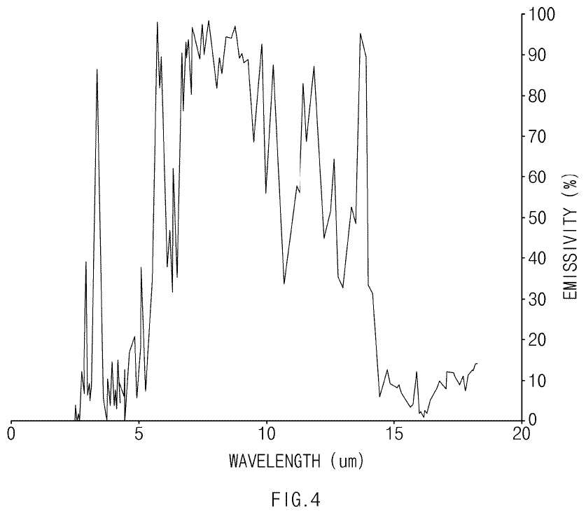

Reflectance and emissivity of the laminate-1 of Manufacture Example 1 for a wavelength in a range from 0.2 to 20 μm were measured, and results are shown in FIGS. 3 and 4.

Specifically, the integrating spheres were mounted on an ultraviolet-visible spectrophotometer (UV-VIS spectrophotometer) and the Fourier Transform Infrared (FT-IR) spectrometer, and then the reflectance and the emissivity of the laminate of the Manufacture Example for the wavelength in the range from 0.2 to 20 μm were measured.

As shown in FIG. 3, it was found that the laminate-1 of Manufacture Example 1 has excellent reflectance for light with a wavelength in a range from 800 to 2,300 nm and excellent emissivity for the atmospheric window wavelength in the range from 8 to 14 μm, thereby having excellent radiative cooling effect.

### (2) Measurement of Wear Resistance

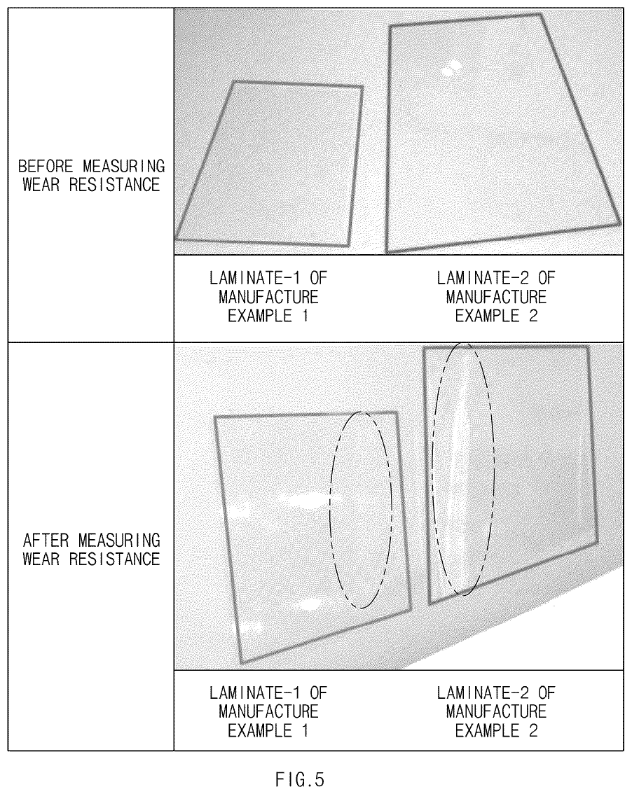

Wear resistance of the laminate-1 of Manufacture Example 1 and the laminate-2 of Manufacture Example 2 was measured, and results are shown in FIG. 5. Specifically, the wear resistance was measured using a pencil hardness (1 Kg) test method described in ASTM D3363.

As shown in FIG. 5, the laminate-1 of Manufacture Example 1 was slightly abraded, but the laminate-2 of Manufacture Example 2 was greatly abraded, showing that the wear resistance is very insufficient.

### (3) Measurement of Light Resistance

Light resistance of the laminate-1 of Manufacture Example 1 and the laminate-2 of Manufacture Example 2 were measured.

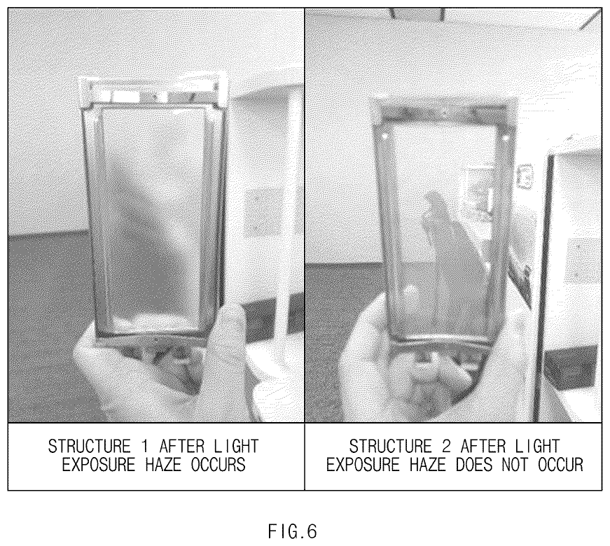

Specifically, after irradiating light for 3 weeks such that a light exposure amount is 185 mJ on the first light reflecting layer or the second light reflecting layer of the laminate-1 of Manufacture Example 1 using ATLAS Ci5000 (Xenon Weather-ometer) equipment, an outer appearance of the laminate was observed with the naked eye. In this regard, a case in which light was irradiated on the first light reflecting layer was specified as structure 1 and a case in which light was irradiated on the second light reflecting layer was specified as structure 2, and durability evaluation results are shown in FIG. 6.

As shown in FIG. 6, in the structure 1 in which light was irradiated on the first light reflecting layer, the first light reflecting layer was degraded by light and haze occurred. On the other hand, the structure 2 in which light was irradiated on the second light reflecting layer was found to have excellent durability against light.

### Comparative Example 1

A laminate-3 for the radiative cooling was manufactured in the same manner as Manufacture Example 1, except that only an indium-doped tin oxide (ITO) layer (average thickness 65 μm) was stacked instead of the second light reflecting layer composed of the indium-doped tin oxide (ITO) layer (the first metal protective layer), a silver (Ag) layer (the metal layer), and the indium-doped tin oxide (ITO) layer (the second metal protective layer).

### Test Example 3

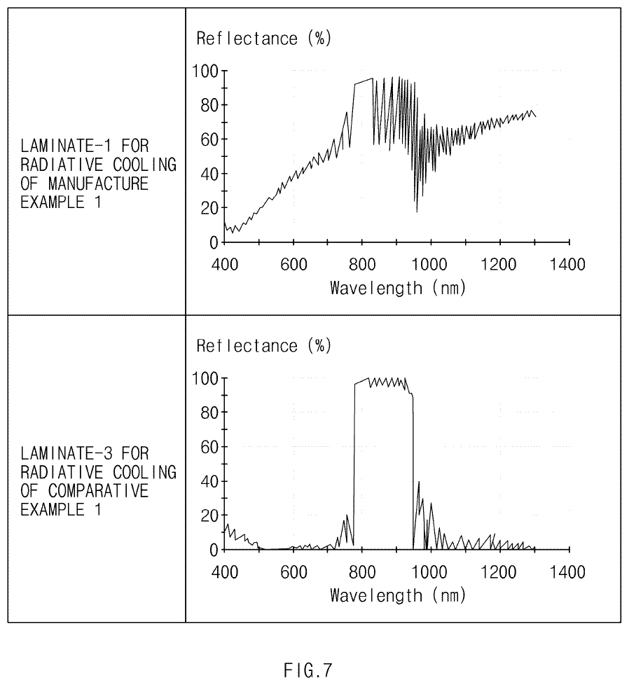

Physical properties, reflectance for light with a wavelength in a range from 400 to 1,400 nm, of the laminate-1 of Manufacture Example 1 and the laminate-3 for the radiative cooling of Comparative Example 1 were measured in the same manner as Test Example 2. Results are shown in FIG. 7.

As shown in FIG. 7, the laminate-1 of Manufacture Example 1 had excellent reflectance for light with a wavelength equal to or higher than 1,000 nm of equal to or higher than 60%. However, the laminate-3 for the radiative cooling of Comparative Example 1 had significantly insufficient reflectance of lower than 20%.

### Comparative Example 2

A laminate-4 for the radiative cooling was manufactured in the same manner as Manufacture Example 1, except that a PET film with an average thickness of 75 μm composed of PET resin (manufacturer: TK chemical, product name: TexPet, Mw: 52,000 g/mol, and a refractive index: 1.7) was used instead of the first light reflecting layer with an average thickness of 135 μm including the first layer (PET layer) and the second layer (PMMA layer).

### Test Example 4

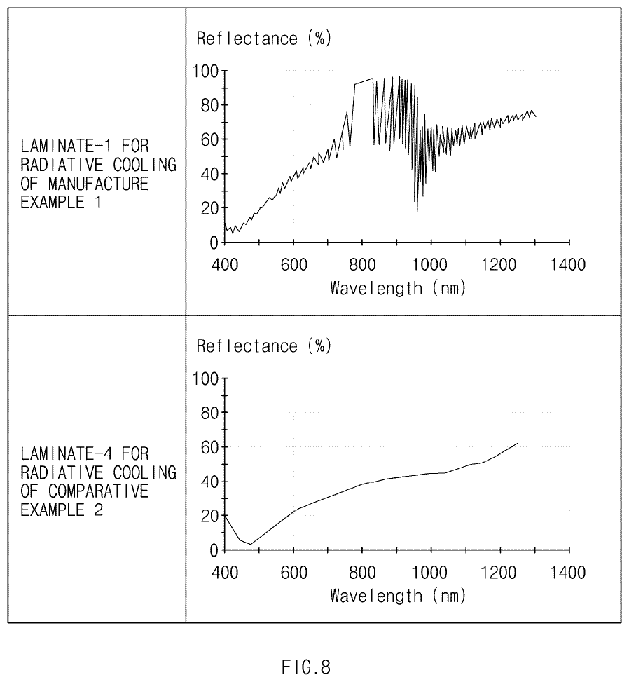

Physical properties, the reflectance for light with the wavelength in the range from 400 to 1,400 nm, of the laminate-1 of Manufacture Example 1 and the laminate-4 for the radiative cooling of Comparative Example 2 were measured in the same manner as Test Example 2. Results are shown in FIG. 8.

As shown in FIG. 8, the laminate-1 of Manufacture Example 1 had excellent reflectance for light with a wavelength in a range from 800 to 1,000 nm of equal to or higher than 60%. However, the laminate-4 for the radiative cooling of Comparative Example 2 had insufficient reflectance of lower than 50%.

The laminate for the radiative cooling according to embodiments of the present disclosure has excellent reflection for light in the ultraviolet band and excellent infrared radiation, thereby having excellent radiative cooling effect. In addition, the laminate for the radiative cooling has excellent durability and wear resistance against the sunlight, and thus it is very suitable as the outdoor radiative cooling material exposed to the sunlight for a long time, such as the exterior of a vehicle or a building.

Hereinabove, although embodiments of the present disclosure have been described with reference to exemplary embodiments and the accompanying drawings, the present disclosure is not limited thereto, but it may be variously modified and altered by those skilled in the art to which the present disclosure pertains without departing from the spirit and scope of the present disclosure claimed in the following claims.

What is claimed is:

1. A laminate for radiative cooling, the laminate comprising:
a first light reflecting layer having a reflectance equal to or higher than 80% for near-infrared light with a wavelength in a range from 780 to 1,300 nm and a transmittance equal to or higher than 70% for visible light with a wavelength in a range from 400 to 780 nm;
a second light reflecting layer on the first light reflecting layer, wherein a first metal protective layer, a metal layer, and a second metal protective layer are sequentially stacked in the second light reflecting layer; and
an infrared radiating layer on the second light reflecting layer.

2. The laminate of claim 1, wherein the first light reflecting layer comprises a first layer containing a first polymer and a second layer containing a second polymer and having a lower refractive index than the first layer alternately stacked.

3. The laminate of claim 1, wherein:
the first light reflecting layer has an average thickness in a range from 50 to 300 μm; and
the second light reflecting layer has an average thickness in a range from 30 to 300 nm.

4. The laminate of claim 1, wherein:
each of the first metal protective layer and the second metal protective layer independently has an average thickness in a range from 15 to 200 nm; and
the metal layer has an average thickness in a range from 1 to 100 nm.

5. The laminate of claim 1, wherein each of the first metal protective layer and the second metal protective layer independently comprises at least one material selected from the group consisting of indium-doped tin oxide, aluminum-doped zinc oxide, fluorine-doped tin oxide, titanium dioxide, neodymium oxide, and silicon dioxide.

6. The laminate of claim 1, wherein the metal layer comprises at least one metal selected from the group consisting of silver, aluminum, gold, aluminum oxide, chromium, and copper.

7. The laminate of claim 1, wherein the infrared radiating layer has an average thickness in a range from 10 to 1,000 μm.

8. A radiative cooling material comprising:
a laminate comprising:
a first light reflecting layer having a reflectance equal to or higher than 80% for near-infrared light with a wavelength in a range from 780 to 1,300 nm and a transmittance equal to or higher than 70% for visible light with a wavelength in a range from 400 to 780 nm;
a second light reflecting layer on the first light reflecting layer, wherein a first metal protective layer, a metal layer, and a second metal protective layer are sequentially stacked in the second light reflecting layer;
an infrared radiating layer on the second light reflecting layer; and
an adhesive layer between the second light reflecting layer and the infrared radiating layer.

9. The radiative cooling material of claim 8, wherein the radiative cooling material is a radiative cooling film for a vehicle roof.

10. The radiative cooling material of claim 9, wherein the first light reflecting layer of the laminate is disposed on an exterior of the vehicle roof.

11. The radiative cooling material of claim 8, wherein the first light reflecting layer comprises a first layer containing a first polymer and a second layer containing a second polymer and having a lower refractive index than the first layer alternately stacked.

12. The radiative cooling material of claim 8, wherein:
the first light reflecting layer has an average thickness in a range from 50 to 300 μm; and
the second light reflecting layer has an average thickness in a range from 30 to 300 nm.

13. The radiative cooling material of claim 8, wherein:
each of the first metal protective layer and the second metal protective layer independently has an average thickness in a range from 15 to 200 nm; and
the metal layer has an average thickness in a range from 1 to 100 nm.

14. The radiative cooling material of claim 8, wherein each of the first metal protective layer and the second metal protective layer independently comprises at least one material selected from the group consisting of indium-doped tin oxide, aluminum-doped zinc oxide, fluorine-doped tin oxide, titanium dioxide, neodymium oxide, and silicon dioxide.

15. The radiative cooling material of claim 14, wherein the metal layer comprises at least one metal selected from the group consisting of silver, aluminum, gold, aluminum oxide, chromium, and copper.

16. The radiative cooling material of claim 8, wherein the infrared radiating layer has an average thickness in a range from 10 to 1,000 μm.

17. A mobility comprising:
a radiative cooling material comprising a laminate, the laminate comprising:
a first light reflecting layer having a reflectance equal to or higher than 80% for near-infrared light with a wavelength in a range from 780 to 1,300 nm and a transmittance equal to or higher than 70% for visible light with a wavelength in a range from 400 to 780 nm;
a second light reflecting layer on the first light reflecting layer, wherein a first metal protective layer, a metal layer, and a second metal protective layer are sequentially stacked in the second light reflecting layer; and
an infrared radiating layer on the second light reflecting layer.
